(19) United States
(12) Patent Application Publication
(10) Pub. No.: US 2015/0310351 A1
(43) Pub. Date: Oct. 29, 2015

(54) PROFILING A POPULATION OF EXAMPLES

(71) Applicant: COLDLIGHT SOLUTIONS, LLC, Wayne, PA (US)

(72) Inventors: Ryan Todd CAPLAN, Huntingdon Valley, PA (US); Bruce F. KATZ, Philadelphia, PA (US); Joseph John PIZONKA, Phoenixville, PA (US)

(21) Appl. No.: 14/669,873

(22) Filed: Mar. 26, 2015

Related U.S. Application Data
(60) Provisional application No. 61/984,333, filed on Apr. 25, 2014.

(51) Int. Cl. G06N 99/00

(52) U.S. Cl. CPC G06N 99/005

(57) ABSTRACT

A method for profiling a population of examples includes a computer receiving a dataset representative of the population of examples, a user selection of a population constraint, and an indication of a goal. The computer generates shallow fixed-depth trees based on the dataset and determines a collection of leaves of the shallow fixed-depth trees meeting the population constraint. Next, the computer sorts the collection of leaves based on a degree to which the goal is met. Then, the computer creates one or more profiles based on the collection of leaves.

### CROSS REFERENCE TO RELATED APPLICATIONS

This application claims the benefit of U.S. Provisional Application Ser. No. 61/984,333, filed Apr. 25, 2014, which is incorporated herein by reference in its entirety.

### TECHNICAL FIELD

The present invention relates generally to methods, systems, and apparatuses for profiling a population of examples using machine learning techniques. The disclosed methods, systems, and apparatuses may be applied to, for example, to describe datasets corresponding to the population in a compact form for human consumption.

### BACKGROUND

Machine learning is a type of artificial intelligence (AI) that seeks to learn the parameters and structures of a model representative of dataset. Once a model has been learned, it may be used to better understanding the underlying data and to make decisions on how to interpret and process new data. For example, a machine learning model can be used to predict the value of a target variable based on several input variables.

In conventional machine learning models, the degree of transparency present in the model is inversely proportional to the usefulness of the model. Thus, there is a tradeoff between description and prediction—the harder the model is to understand from the user's perspective, the better it is at making predictions. With conventional machine learning models, it is difficult to understand why a model is making certain predictions without sacrificing the complexity, sophistication, and accuracy of the model. Accordingly, there is a need for describing machine learning models in a compact form suitable for human consumption.

Conventional machine learning models are also not well suited for understanding extreme cases present in a dataset. For example, in the context of a model representative of spending at a particular store, the store owner may desire to know what type of customer spends a large amount of money on purchases (e.g., the top 5% of all spenders based on amount spent). Additionally, the store owner may desire to know what type of customer browses for a long time but doesn't purchase anything. With this information, the store owner can optimize the allocation of marketing and customer service resources based on customer type. Thus, there is also a need for machine learning models to be adapted to better describe extreme cases present in a given population.

### SUMMARY

Embodiments of the present invention address and overcome one or more of the above shortcomings and drawbacks, by methods, systems, and apparatuses of profiling a population of examples using data-driven techniques that provide an at-a-glance description of the data from the point of view of goal-fulfillment. Each example is a collection of features and values and may include, without limitation, a person (e.g., a customer, a patient, etc.), a record, and a device.

According to some embodiments, a computer-implemented method for profiling a population of examples includes a computer receiving a dataset representative of the population of examples, a user selection of a population constraint, and an indication of a goal. The population constraint may correspond, for example, to a percentage of the population that must be covered by at least one leaf in the collection of leaves. The goal may be, for example to maximize (or minimize) a characteristic feature of the population. Once the dataset has been received and the goal and population constraint are set, the computer generates a plurality of shallow fixed-depth trees based on the dataset. Next, the computer determines a collection of leaves of the plurality of shallow fixed-depth trees meeting the population constraint. For example, in some embodiments, a filtering process is used wherein leaves of the tree that do not meet the population constraint are automatically removed. Once the collection of leaves is generated, the computer sorts it based on a degree to which the goal is met. Then, the computer creates one or more profiles based on the collection of leaves.

In the aforementioned method, the shallow fixed-depth trees may be generated, for example, using one or more decision tree algorithms known in the art. The decision tree algorithm may form splits in the shallow fixed-depth trees to maximize a combination of population size and mean goal value. In some embodiments, the criterion used in creating splits in the data is information gain.

According to other embodiments, a second computer-implemented method for profiling a population of examples includes a computer receiving a dataset representative of the population of examples. The computer determines a subset of the dataset representative of highest performing members of the dataset according to one or more predetermined criteria and generates a plurality of clusters based on the subset of the dataset. In one embodiment, these clusters are disjoint clusters generated, for example, using a k-means clustering algorithm. Next, the computer performs a feature-value pairing process on each cluster. This feature-value pairing process includes forming a plurality of first feature-value pairs that maximally deviate from the population of examples, and forming a plurality of second feature-value pairs that maximally deviate from remaining clusters in the plurality of clusters. Then, the computer creates one or more profiles based on the plurality of first feature-value pairs and the plurality of second feature-value pairs.

In some embodiments of the aforementioned second computer-implemented method for profiling a population of examples, the subset of the dataset representative of highest performing members of the dataset is identified by first identifying a group of members of the population of examples meeting the one or more predetermined criteria. Next, a ranking of the group is created according to a degree to which each respective member of the group meets the one or more predetermined criteria. Then, the subset of the dataset is selected based on the ranking. In one embodiment, the subset is limited by a predetermined percentage value selected by a user. In some embodiments, the subset of the dataset comprises the highest-ranking (or lowest-ranking) members according to the predetermined criteria. In these embodiments, the subset sized according to the predetermined percentage value.

In some embodiments, if each member of the population of examples is not represented by the one or more profiles, an iterative successive profiling process is performed to assign each member of the population to a profile. For example, in one embodiment, a new subset of the population is created which includes a predetermined percentage of members of the population of examples that are not assigned to the one or more profiles. This exact value of the predetermined percentage may be based on, for example, on the hardware constraints associated with the computer. Once the new subset is created, it is used to create one or more additional profiles. This successive profiling process repeats iteratively until each member of the population has been assigned to at least one profile.

According to other embodiments a modeling computing system includes a processor, a plurality of modeling components, and a profile database. The processor is configured to retrieve a population dataset from a population database and execute the modeling components. The modeling components include a tree formation component, a leaf processing component, clustering component, and a feature-value pair formation component. The tree formation component is configured to process the population dataset into decision tree data structures. The leaf processing component is configured to identify leaves of the decision tree structures meeting a population constraint. The clustering component forms disjoint clusters based on the population dataset and the feature-value pair formation component generates one or more profiles based on feature-value pairs present in the disjoint clusters. The profile database is configured to store the generated profiles.

In some embodiments, the aforementioned modeling computing system includes additional components. For example, in one embodiment, the modeling components executed by the processor include dataset filtering component which is configured to identify a highest-ranking subset or a lowest-ranking subset of the population dataset based on one or more criteria. The clustering component in these embodiments may form the disjoint clusters based on the subset identified by the dataset filtering component. In other embodiments, the system includes a display module which is configured to present a graphical depiction of the generated profiles on a display. This graphical depiction may include, for example, a listing of each feature-value pair associated with the profiles, an indication of a degree to which each respective feature-value pair in the listing meets a user-defined goal, and/or an indication of how much of the population dataset meets each respective feature-value pair included in the listing.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides an overview of a system for generating profiling a population of examples, according to some embodiments of the present invention;

FIG. 2 provides an illustration of a decision tree, as may be used in some embodiments of the present invention;

FIG. 3 provides a process for generating precisely descriptive profiles, according to some embodiments of the present invention;

FIG. 4 provides an example of a process for building a fixed depth decision tree, according to some embodiments of the present invention;

FIG. 5 provides an illustration of a process for generating mutually exclusive profiles of a population, according to some embodiments of the present invention;

FIG. 6 provides an overview process of generating “fuzzy” profiles, according to some embodiments of the present invention;

FIG. 7 provides a process for successive profiling, according to some embodiments of the present invention;

FIG. 8A provides an example graphical interface showing how output information may be presented, according to some embodiments of the present invention;

FIG. 8B provides a second example graphical interface which shows how output information may be presented, according to some embodiments of the present invention; and

FIG. 9 illustrates an exemplary computing environment within which embodiments of the invention may be implemented.

### DETAILED DESCRIPTION

The following disclosure describes the present invention according to several embodiments directed at methods, systems, and apparatuses for profiling a population of examples using data-driven techniques that provide an at-a-glance description of the data from the point of view of goal-fulfillment. Each example is a collection of features and values and may include, but is not limited to, a person (e.g., a customer or patient), a record, or a device. The term “profiling”, as used herein, refers to the process by which characteristic features in a given dataset are identified according to the importance in explaining differential performance of a group of examples against the output goal. A goal is a feature that one is trying to maximize (or minimize). For example, features such as churn or hospital cost may be used as the goal when sorting. The techniques described herein may be useful, for example, in identifying the key factors that explain differential performance in a given audience of examples. For example, why do some customers purchase horror movies while others do not? This process attempts to best explain the differences in those customers that do and those that do not exhibit a certain behavior (e.g., purchasing horror movies) using an automated process of discovering what makes up the key differences between the groups. As an example, using the techniques described herein, “males over 24 that live in the NE region” may be found to be 3 times more likely to watch horror movies than people that do not match this description.

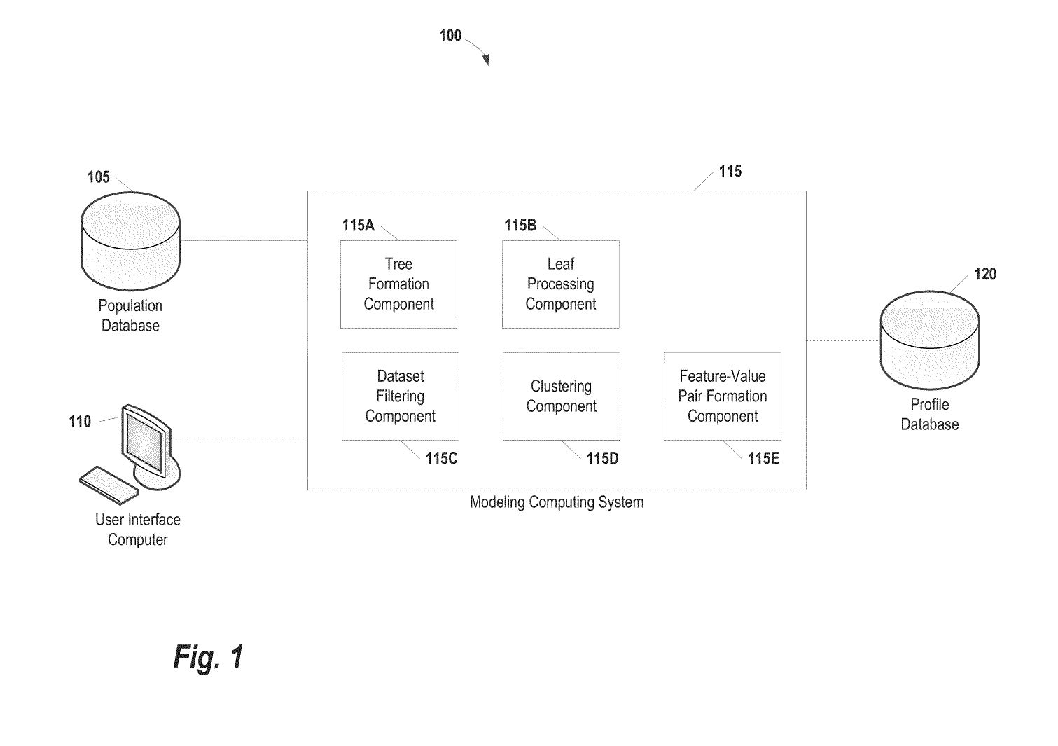

FIG. 1 provides an overview of a system 100 for generating profiles for a population of examples, according to some embodiments of the present invention. Briefly, the system 100 applies machine learning techniques to generate one or more profiles which define groups of examples within the population. Each profile comprises key defining and differentiating features and attributes of a group of examples. A profile may be defined as a conjunction of a plurality of conditions. Each condition is a feature-attribute pair (e.g., “STATE=NJ”) which a member of the population will either meet or not meet. For example, one profile may be the conjunction of the conditions “State=NJ.” “Age=[50 to 65],” and “Income=low.” The more conditions in a profile, the narrower the population band and the more likely that a higher mean goal value will be found.

Profiles are a means of describing data in a compact form for human consumption, and, as such, stand in contrast to “black-box” models with possibly greater predictive power but less transparency. The general aim is to understand how a goal is met (in the case of a binary goal) or is maximized (in the case of a discrete goal). For example, one may wish to understand the characteristics of customers likely to churn (a binary goal), or understand the characteristics of customers likely to spend greater than average amounts (a continuous scale). Although profiles may be produced by traditional machine-learning representations such as decision trees, the principle of transparency dictates that something less than the full tree is presented as the result. Accordingly, the depth of the tree may be limited and, in addition, only those leaves of the trees meeting certain constraints will be of interest (e.g., those that contain a minimal population count). Profiles also stand in contrast to traditional clustering techniques. For example, profiles are more goal-oriented than clustering, and focus on high performers rather than the population as a whole.

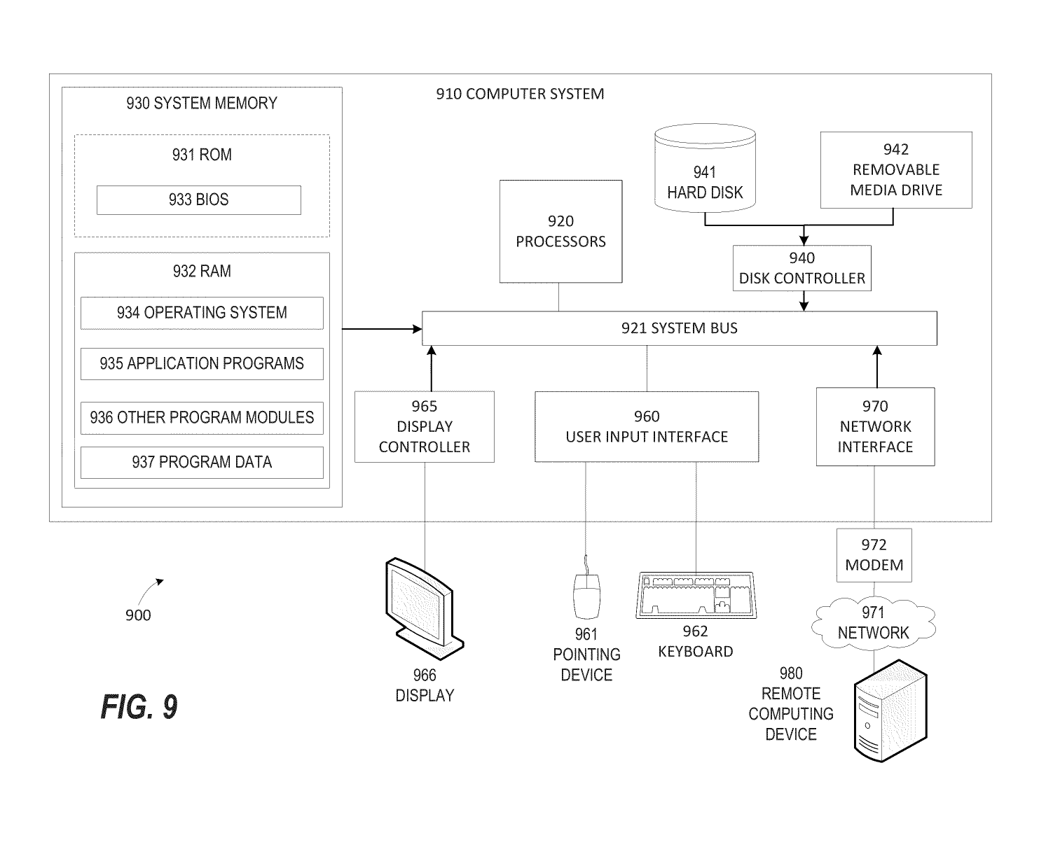

Continuing with reference to FIG. 1, the system 100 includes a Modeling Computing System 115 operably coupled to a Population Database 105 and a User Interface Computer 110. Based on input received from the User Interface Computer 110, the Modeling Computing System 115 retrieves population datasets from the Population Database 105 and processes those datasets using a variety of components (described in further detailed below) to generate one or more profiles which are then stored in a Profile Database 120 or displayed, with or without additional information, on the User Interface Computer 110 (see the description of FIG. 9 below for more information on how data may be presented on the User Interface Computer 110).

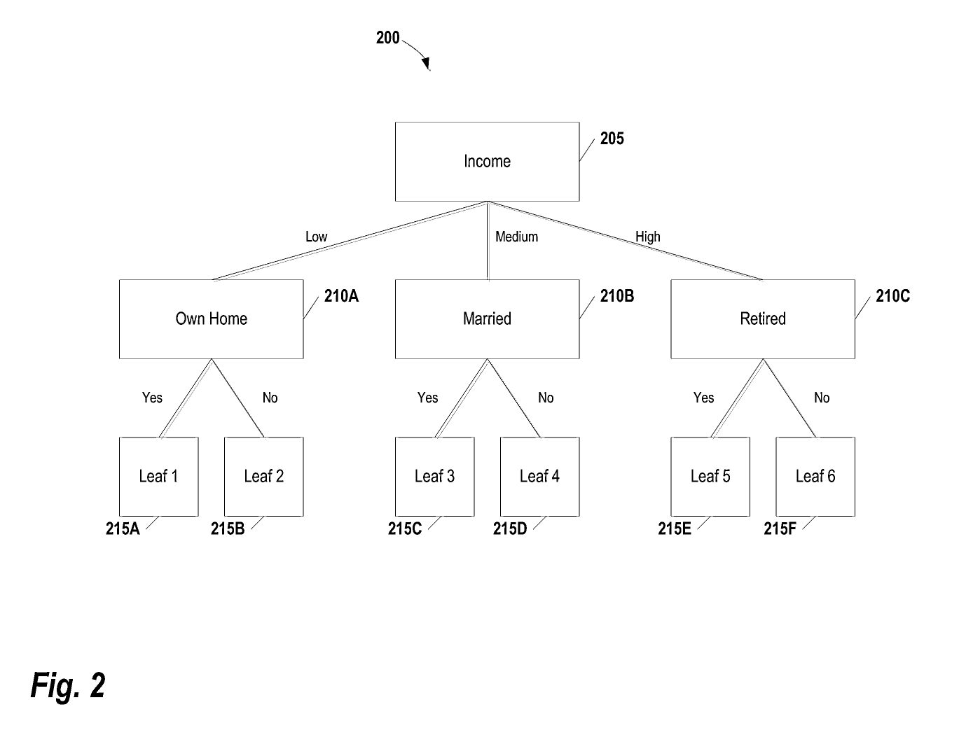

A Tree Formation Component 115A processes the dataset received from the Population Database 105 into decision tree data structures. As is understood in the art, decision trees are classification schema in which every node or vertex represents a splitting feature and every edge represents an attribute dividing the population into disjoint subsets. FIG. 2 provides an illustration of a decision tree 200, as may be used in some embodiments of the present invention. In this example, the top dividing feature is income 205, which divides the population into 3 subsets: low, medium, and high. Next, splitting features “Own Home” 210A, “Married” 210B, and “Retired” 210C are used to further divide the population into leaves 215A, 215B, 215C, 215D, 215E, and 215F. The leaves 215A, 215B, 215C, 215D, 215E, and 215F are at the bottom of the tree and, by definition, have no further dividers. For example, leaf 4 215D represents the subset of the population that has medium income and is not married. The Tree Formation Component 115A may utilize various techniques for generating decision trees. For example, in some embodiments splitting measures such as information gain are employed. In other embodiments, heuristically guided search techniques are used such that splits are formed that tend to maximize a combination of population size and mean goal value. Additionally, in some embodiments, various conventional decision tree algorithms may be utilized such as, without limitation, Classification and Regression Trees (CART), Iterative Dichotomiser 3 (ID3), C4.5, and Very Fast Decision Trees (VFDT) algorithms.

Returning to FIG. 1, a Leaf Processing Component 115B performs various functions on the leaves present on decision trees generated by the Tree Formation Component 115A. These functions may include, for example, collecting leaves that meet a particular population constraint. In this context, population constraint refers to a minimal population (e.g., 1%) that must be covered by a leaf of the decision tree. Additionally, the Leaf Processing Component 115B may be configured to sort the leaves in a tree by the degree to which a particular goal is met. In some embodiments, the output of the Leaf Processing Component 115B is one or more profiles which are then stored in the Profile Database 120 and/or presented to a user at the User Interface Computer 110.

The Modeling Computing System 115 further includes a Dataset Filtering Component 115C which generates subsets of the population dataset received from the Population Database 105 based on one or more criteria. In some embodiments, the Dataset Filtering Component 115C is configured to determine the top n % or the bottom n % of the population according to a population constraint. In this context, n is a predetermined number selected, for example, by a user. For example, if the population constraint is “high income earners,” the Dataset Filtering Component 115C can identify the top 10% of all members of the population identified as having high income.

Clustering Component 115D forms disjoint clusters based on a population dataset or a filtered subset of that dataset. The Clustering Component 115D may be configured to execute various clustering algorithms including, without limitation, k-means clustering, fuzzy c-means clustering, hierarchical clustering, expectation-maximization clustering, quality threshold clustering, minimum spanning tree based clustering, kernel k-means clustering, and density-based clustering algorithms.

A Feature-Value Pair Formation Component 115E determines pairs of features and values present in clusters generated by Clustering Component 115D. In some embodiments, the Feature-Value Pair Formation Component 115E is also configured to identify feature-value pairs which deviate from the total set of feature-value pairs calculated for a particular cluster. For example, in one embodiment, for each cluster, feature-value pairs are formed that maximally deviate from the original population and/or other clusters. The deviation of each feature-value pair can be determined using any technique known in the art. In some embodiments, the feature-value pairs vary by value relative to the mean of the population (or other clusters). For example, if a cluster has a mean income of $126,000, this could be 2.1 standard deviations above the mean for the population as a whole. In some embodiments, the output of the Feature-Value Pair Formation Component 115E is one or more profiles which are then stored in the Profile Database 120 and/or presented to the user at the User Interface Computer 110.

It should be noted that the components 115A, 115B, 115C, 115D, and 115E illustrated in FIG. 1 are only a sampling of the different components that may be included in the Modeling Computing System 115. In some embodiments, the functionality corresponding to these components can be merged and/or supplemented with additional functionality. Additionally, in other embodiments, the Modeling Computing System 115 may include additional components that provide additional modeling functionality not described herein.

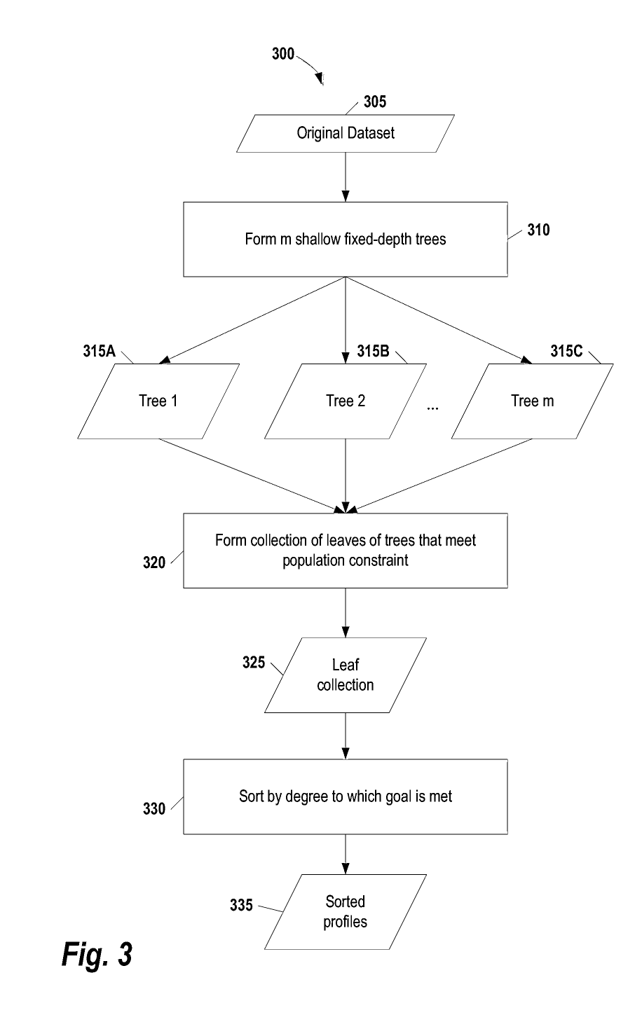

FIG. 3 provides a process 300 for generating precisely descriptive profiles, according to some embodiments of the present invention. This process may be implemented for example, using the system 100 illustrated in FIG. 1. The aim of precisely descriptive profiles is to produce as many descriptions of high or low performing population segments as possible and, in some embodiments, regardless of possible overlap between such segments. By construction, every member of the sub-population meets all the conditions of the profile. Profiles are drawn from a number of decision trees, and ranked by goal feature value. The user may control the number of conditions in each profile and other parameters such as, for example, a minimum population percentage that each precisely descriptive profile must describe.

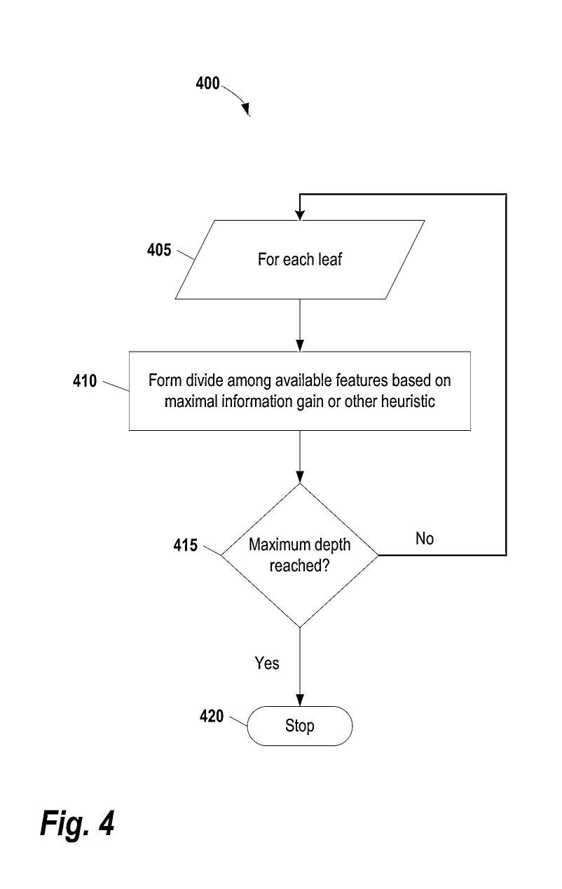

Continuing with reference to FIG. 3, at 310, an original dataset 305 is processed to form a predetermined number of shallow fixed depth trees 315A, 315B, and 315C. Any technique known in the art may be used to form the decision trees. The exact number of trees may vary, for example based on user input or criteria such hardware constraints. FIG. 4 provides an example of a process 400 for building a fixed depth decision tree, according to some embodiments of the present invention. The input 405 to the process 400 is each possible leaf to be added to the tree. Next, at 410, a divide is formed among available features based on, for example, information gain or another heuristic known in the art. At 415, the depth of the tree is evaluated to determine if it reached a predetermined maximum depth. If the maximum depth has not been reached, the process repeats. However, if the maximum depth is reached, the process ends at 420.

Returning to FIG. 3, the shallow fixed depth trees 315A, 315B, and 315C describe the entire population set. Thus, once the trees 315A, 315B, and 315C are formed, the leaves are processed at 320 to form a collection of leaves 325 that meet a predetermined population constraint. For example, the leaves may be filtered to remove those leaves that do not contain at least a predetermined percentage of the population, as specified by the population constraint. In some embodiments, this population constraint is specified at runtime, for example, by user input. In other embodiments, default values may be used for the population constraint. The population constraint may be specified in various ways. In some embodiments, the predetermined population constraint specifies a minimum or maximum percentage of the target population. For example, the predetermined population constraint may specify that only the top 5% of the high-income individuals (i.e., the highest of the high income individuals). In some embodiments, the process 300 illustrated in FIG. 3 is extended to profile a population by percent of goal or aggregate percent of goal. Then, instead of specifying a minimum (or maximum) population percentage at 320, the user may specify a goal threshold. For example, the user may specify that the goal must be a churn rate of at least 35%. As a further variant, in some embodiments, in the case of cost or similar feature, the user may specify an aggregate cost over all members of a profile that must be met for the profile to be admissible. In some embodiments, if no leaves meet the population criterion at the specified depth, the system automatically generates a tree with a lower depth to alleviate this difficulty.

Next, at 330, the collected leaves 325 are sorted by the degree to which the goal is met (maximized or minimized, as appropriate). For example if the trees 315A, 315B, and 315C originally included 500 different leaves, 64 of those leaves may be determined to meet the population constraint at 320. Then, at 330, those 64 leaves are sorted based on whether the model is designed to minimize or maximize the goal. Various sorting algorithms known in the art may be used to sort the leaves including, without limitation, quicksort, merge sort, insertion sort, and/or bubble sort algorithms. In some embodiments, profiles associated with minimum performers are generated as an alternative, or in addition to, maximum performers. For example, a company may wish to know which of its customers are less likely to churn. Algorithmically, the process of generating these profiles is similar, except that when targeting minimum performers, the greatest utility is assigned to profiles with the lowest mean goal values. The sorting applied at 330 results in one or more sorted profiles 335. In some embodiments, to reduce the number of similar descriptions, a number of filtering techniques can be employed on the sorted profiles 335. For example, the most general filtering technique is to keep a running count of appearances of feature-value pairs in prior profiles, and removing succeeding profiles containing this pair if a threshold value is exceeded.

In the table below, three precisely descriptive profiles are shown that may result from applying the process 300 to a population of users. In this example, each profile includes three conditions that maximize the probability of customer churn and covering at least 1% of the population are derived from a database of customers, their characteristics, and a flag indicating whether they churned or not. The aim of this example is to produce profiles with significantly higher than mean values of churn (in this example, the mean probability of churn over the entire population is approx. 10%).

| | Population | Probability | |
|---|---|---|---|
| Profile | Size | of Churn | Conditions |
| Profile 1 | 1.12% | 37.6% | State = NJ |
| | | | Age = [50 to 65] |
| | | | Income = low |
| Profile 2 | 1.07% | 33.2% | State = PA |
| | | | Do not call = true |
| | | | Income = medium |
| Profile 3 | 1.27% | 24.2% | Own home = false |
| | | | Do not call = true |
| | | | Income = low |

Profiles may be generated either with conjunctions and/or disjunctions between the conditions. Additionally, in some embodiments, the use of a conjunction or disjunction is detected automatically based on the type of condition specified by the user. For example, in the context of a state field which includes mutually exclusive values, a condition specified “STATE=NJ, AL” may be interpreted as having an implicit “or” relation such that it is interpreted as STATE=NJ or STATE=AL.

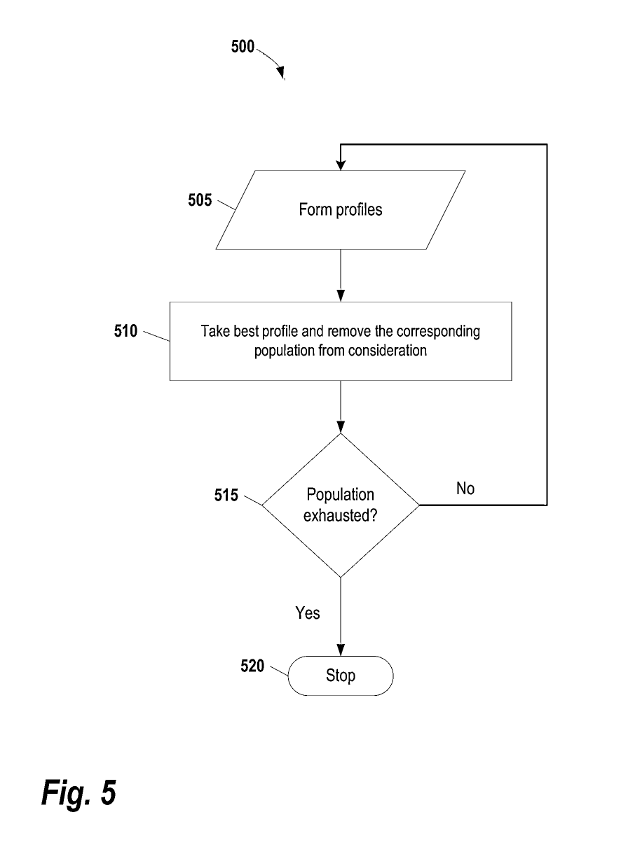

FIG. 5 provides an illustration of a process 500 for generating mutually exclusive profiles of a population, according to some embodiments of the present invention. This process 500 may be applied as a supplement to the process 300 illustrated in FIG. 3 to ensure that profiles do not include overlapping members of the population. The input 505 includes a group of profiles formed, for example, using the process 300 illustrated in FIG. 3. At 510, the “best” profile is selected from the input 505 and the population covered by the profile is subtracted from the population as a whole. The criteria for selecting the “best” profile may include, for example, the profile with the highest mean goal value (or lowest in the case of minimization) that also meets the population constraint. Next, at 515, the population is evaluated to determine if any additional profiles remain to be processed (i.e., whether it is exhausted). If it is not exhausted, the process is repeated. Once the population is exhausted, the process stops at 520. This ensures that each profile covers a separate population subset. Mutually exclusive profiles generated using the process 500 illustrated in FIG. 5 may be useful in various applications including, for example, targeted marketing.

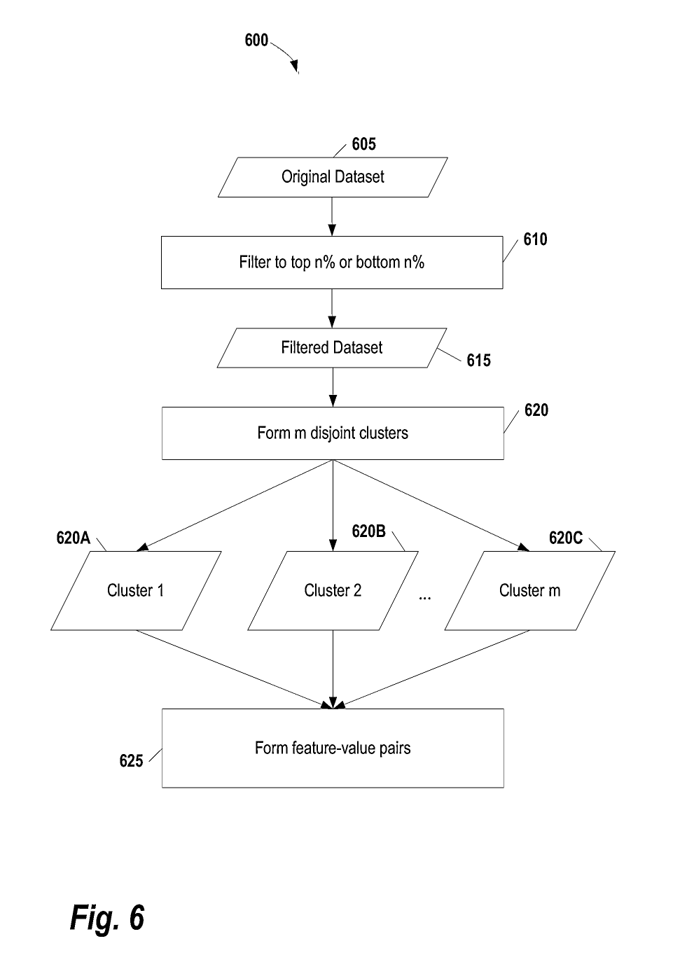

FIG. 6 provides an overview process 600 of generating “fuzzy” profiles, according to some embodiments of the present invention. Unlike their more precisely encoded counterparts described above with respect to FIG. 3, fuzzy profiles are formed by first skimming off the highest or lowest performing examples in a dataset, clustering these sets of examples, and then attempting to describe this sub-population with a set of characteristic feature-value pairs. The fuzziness arises because these descriptions will not necessary apply to every example in the set. Moreover, the characteristics will be one of degree, reflecting either the deviance of the cluster from the population as a whole, or the deviance of the cluster from other clusters classifying this sub-population, rather than a discrete conjunction of conditions.

In FIG. 6, an original dataset 605 representative of a population is received, for example, via retrieval from local storage. The dataset includes information regarding various features that may be present in the population. For example, a dataset of medical data gathered by a hospital may include information such as age, sex/gender, familial medical history, habits (e.g., whether an individual smokes or drinks alcohol), diseases (e.g., diabetes), as well as derived information such as measurement results (e.g., electrocardiogram data) and the diagnosis or diagnoses made by the medical staff.

Continuing with reference to FIG. 6, at 610, the original dataset 605 is filtered to identify the top n % or the bottom (i.e., lowest) n % of the population according to a desired criterion, where n is a predetermined population threshold value number selected, for example, by a user. For example, in some embodiments, a group of members of the population meeting the desired criterion are first identified. Next, the group is ranked according to the degree to which each member meets the desired criterion. Then, the top/bottom n % is selected based on the ranking.

At 620, a predetermined number of disjoint clusters 620A, 620B, and 620C are formed based on the filtered dataset 615, using any clustering technique known in the art. For example, in one embodiment, the clusters are formed using k-means clustering techniques. In some embodiments, instead of forming m clusters at 620 as described above, profiles are formed hierarchically by first describing the exceptional cohort as a whole, dividing this into two (or more) clusters and describing these, and then further dividing these into clusters, etc. At 625, characteristic feature-value pairs are formed for each cluster. In one embodiment, two sets of feature-value pairs are formed for each cluster: feature-value pairs that maximally deviate from original population and feature-value pairs that maximally deviate from other clusters

One example of use of fuzzy profiles is illustrated in the table below. The top 5% of hospital stays by cost are segregated from the population as a whole for analysis. These are then divided into 2 clusters as illustrated in the following table:

| | | Standard Deviation |
|---|---|---|
| | | from Population |
| Profile | Condition | Mean |
| Profile 1 | Primary diagnosis = M. infarction | 2.15 |
| | Age = [50 to 65] | 1.78 |
| | Diabetes = yes | 1.42 |
| Profile 2 | Primary diagnosis = Stage 4 cancer | 1.92 |
| | Smoking = yes | 1.71 |
| | Age = [65 to 75] | 1.22 |

The profiles illustrate two fundamental tendencies for this cohort: heart attack patients and patients with advanced cancer. Each profile includes a list of conditions ranked according to the standard deviation of prominence of each condition relative to the population as a whole. Note that, unlike the precisely descriptive process 300 illustrated in FIG. 3, these are merely tendencies. Thus, not every member of the segregated cohort may fall into these two buckets, and more clusters (with fewer members) may reveal other groups.

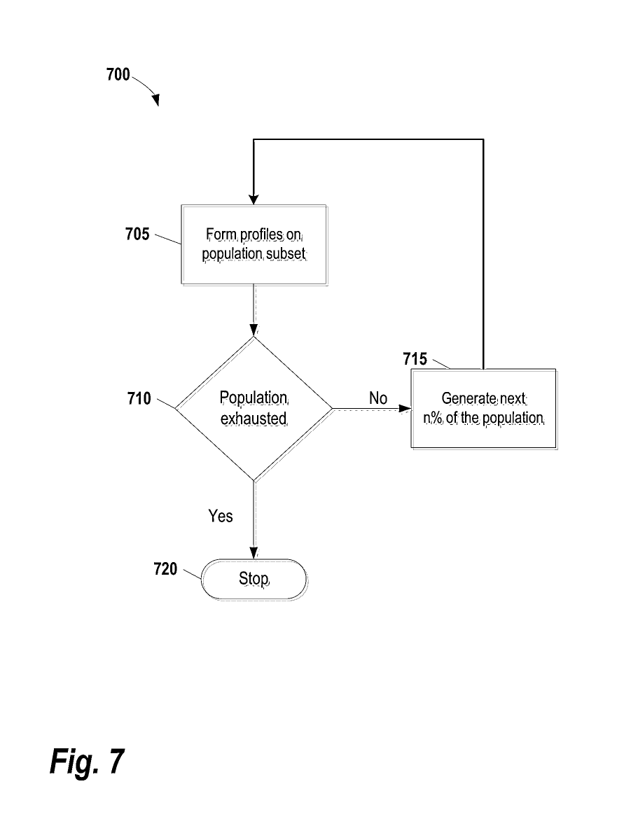

FIG. 7 provides a process 700 for successive profiling, according to some embodiments of the present invention. In FIG. 7, fuzzy profiles are formed on successive subsets of the population, until the entire population is described. Each subset includes a predetermined percentage of the population, with the percentage selected based on, for example, user selection or other criteria. At 705, profiles are formed based on the population subset, for example, using the process 600 described above with respect to FIG. 6. At 710, the population is evaluated to determine if it is exhausted (i.e., each member of the population has been assigned to a profile). If the population is not exhausted, at 715, a new subset is generated using a predetermined percentage of the remaining population. This predetermined percentage may be set based, for example, on user input or hardware constraints. If the population is exhausted, the process 700 stops at 720.

Profiles generated using the techniques described herein may have various applications in analyzing datasets corresponding to populations of users. For example, in the commercial context, profiles may be used as a way to find audiences or groups of customers that exhibit behavior that is different than the average customer. How this is measured will vary from industry to industry, but typically use some cost or revenue amount to measure performance. For example, in healthcare, a payer looks at how much spending is associated with each individual member. This may be used, for example, for underwriting and setting stop loss amounts. Profiles can be also used to find groups of members that are higher risk than normal. One way to do this would be to identify members with cancer, organ transplants, or chronic conditions such as diabetes. This simple selection will identify many members that require more resources than their health counterparts. Profiles will identify novel ways to find other, less obvious members. An example may be a population of 10,000 members that are between 30 and 45 years old, have frequent office visits, and use painkillers. This group of members could be improperly treated or are potentially addicted to painkillers. With either potential issue, further research could be used to find the true issue.

In a subscription-based business, a company can use profiles to detect groups of customers that are likely to remain loyal to the company. This information can be used to drive marketing or promotional programs to further engage customers. In some cases, additional marketing may not be necessary. Consider, for example, a company that has 1 million subscribers and an annual churn rate of 8%. Profiles may identify a group of 50,000 customers that have been a customer between 5 and 10 years, have your highest tier of service, and have high levels of usage and have an annual churn rate of 0.5%. This means that, over the course of a year, only 250 customers will leave.

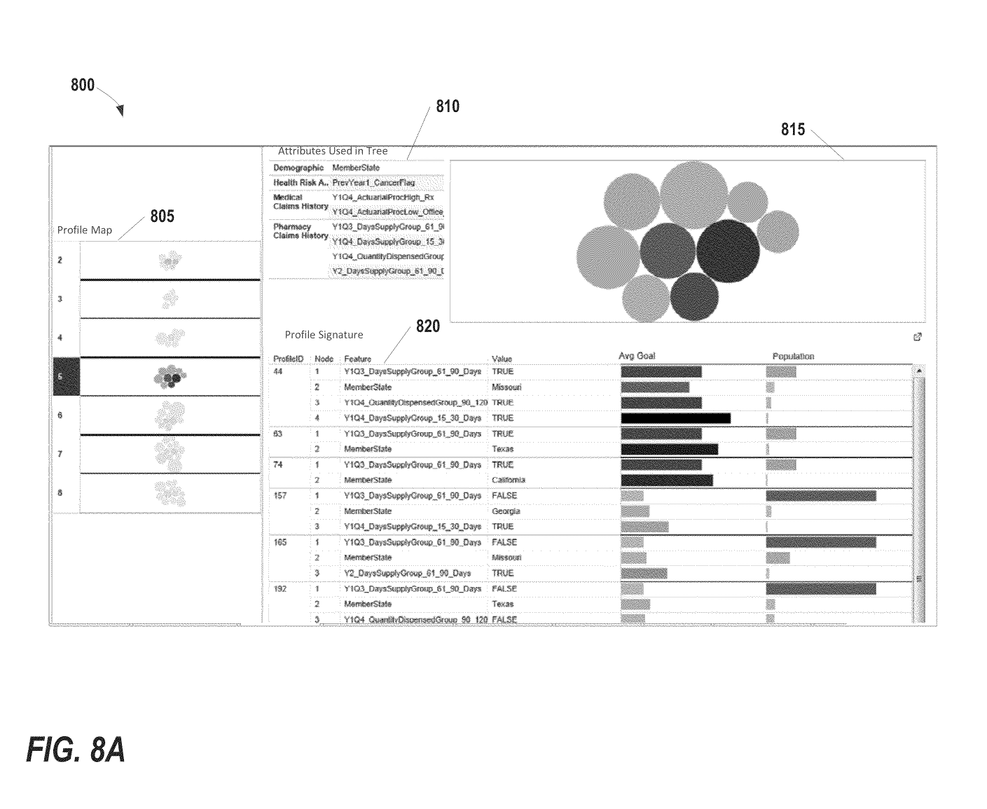

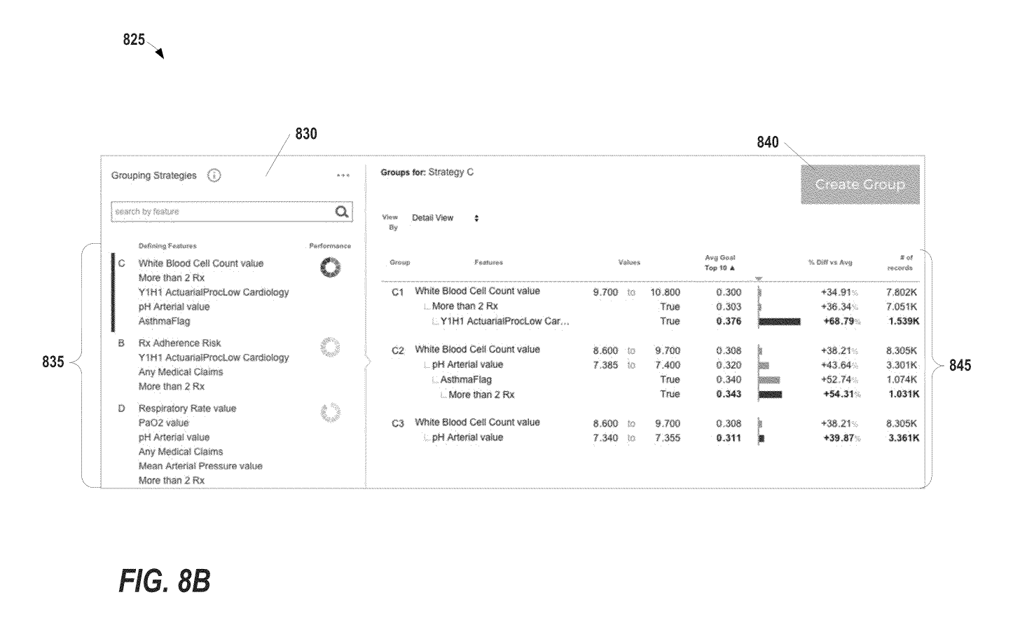

FIG. 8A provides an example graphical interface 800 which shows how output information may be presented, according to some embodiments of the present invention. A Profile Map Area 805 shows each profile group generated based on the population dataset. When a particular profile group is selected in the Profile Map Area 805, its corresponding data is displayed on the right side of the graphical interface 800. An Attribute Data Set Section 810 shows the attributes used to generate the selected profile group. The Cluster Display Section 815 shows the sizes of different clusters within the profile group. Individual clusters may be distinguished, for example, through the use of different colors (or shading, as shown in FIG. 1). A Profile Signature Section 820 displays an identifier for each profile included in the selected profile grouping, along with its corresponding feature-value pairs. Additionally, the Profile Signature Section 820 in this example includes information for each feature-value pair which indicates the degree to which it corresponds to the goal and the number of members of the population that the pairing covers.

FIG. 8B provides a second example graphical interface 825 which shows how output information may be presented, according to some embodiments of the present invention. A Profile Grouping Strategy Area 830 shows each profile group generated based on the population dataset. An Attribute Data Set Section 835 within the Profile Grouping Strategy Area 830 shows the attributes used to generate the selected profile group. When a particular profile group is selected in the Profile Grouping Strategy Area 830, its corresponding data is displayed on the right side of the graphical interface 825. A Profile Signature Section 845 displays an identifier for each profile included in the selected profile grouping, along with its corresponding feature-value pairs. Additionally, the Profile Signature Section 845 in this example includes information for each feature-value pair which indicates the degree to which it corresponds to the goal and the number of members of the population that the pairing covers. Users can create new groups for the population dataset by activating a Create Group Button 840.

FIG. 9 illustrates an exemplary computing environment 900 within which embodiments of the invention may be implemented. For example, computing environment 900 may be used to implement one or more components of system 100 shown in FIG. 1. Computers and computing environments, such as computer system 910 and computing environment 900, are known to those of skill in the art and thus are described briefly here.

As shown in FIG. 9, the computer system 910 may include a communication mechanism such as a system bus 921 or other communication mechanism for communicating information within the computer system 910. The computer system 910 further includes one or more processors 920 coupled with the system bus 921 for processing the information.

The processors 920 may include one or more central processing units (CPUs), graphical processing units (GPUs), or any other processor known in the art. More generally, a processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general-purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

Continuing with reference to FIG. 9, the computer system 910 also includes a system memory 930 coupled to the system bus 921 for storing information and instructions to be executed by processors 920. The system memory 930 may include computer readable storage media in the form of volatile and/or nonvolatile memory, such as read only memory (ROM) 931 and/or random access memory (RAM) 932. The RAM 932 may include other dynamic storage device(s) (e.g., dynamic RAM, static RAM, and synchronous DRAM). The ROM 931 may include other static storage device(s) (e.g., programmable ROM, erasable PROM, and electrically erasable PROM). In addition, the system memory 930 may be used for storing temporary variables or other intermediate information during the execution of instructions by the processors 920. A basic input/output system 933 (BIOS) containing the basic routines that help to transfer information between elements within computer system 910, such as during start-up, may be stored in the ROM 931. RAM 932 may contain data and/or program modules that are immediately accessible to and/or presently being operated on by the processors 920. System memory 930 may additionally include, for example, operating system 934, application programs 935, other program modules 936 and program data 937.

The computer system 910 also includes a disk controller 940 coupled to the system bus 921 to control one or more storage devices for storing information and instructions, such as a magnetic hard disk 941 and a removable media drive 942 (e.g., floppy disk drive, compact disc drive, tape drive, and/or solid state drive). Storage devices may be added to the computer system 910 using an appropriate device interface (e.g., a small computer system interface (SCSI), integrated device electronics (IDE), Universal Serial Bus (USB), or FireWire).

The computer system 910 may also include a display controller 965 coupled to the system bus 921 to control a display or monitor 966, such as a cathode ray tube (CRT) or liquid crystal display (LCD), for displaying information to a computer user. The computer system includes an input interface 960 and one or more input devices, such as a keyboard 962 and a pointing device 961, for interacting with a computer user and providing information to the processors 920. The pointing device 961, for example, may be a mouse, a light pen, a trackball, or a pointing stick for communicating direction information and command selections to the processors 920 and for controlling cursor movement on the display 966. The display 966 may provide a touch screen interface that allows input to supplement or replace the communication of direction information and command selections by the pointing device 961.

The computer system 910 may perform a portion or all of the processing steps of embodiments of the invention in response to the processors 920 executing one or more sequences of one or more instructions contained in a memory, such as the system memory 930. Such instructions may be read into the system memory 930 from another computer readable medium, such as a magnetic hard disk 941 or a removable media drive 942. The magnetic hard disk 941 may contain one or more datastores and data files used by embodiments of the present invention. Datastore contents and data files may be encrypted to improve security. The processors 920 may also be employed in a multi-processing arrangement to execute the one or more sequences of instructions contained in system memory 930. In alternative embodiments, hard-wired circuitry may be used in place of or in combination with software instructions. Thus, embodiments are not limited to any specific combination of hardware circuitry and software.

As stated above, the computer system 910 may include at least one computer readable medium or memory for holding instructions programmed according to embodiments of the invention and for containing data structures, tables, records, or other data described herein. The term “computer readable medium” as used herein refers to any medium that participates in providing instructions to the processors 920 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 941 or removable media drive 942. Non-limiting examples of volatile media include dynamic memory, such as system memory 930. Non-limiting examples of transmission media include coaxial cables, copper wire, and fiber optics, including the wires that make up the system bus 921. Transmission media may also take the form of acoustic or light waves, such as those generated during radio wave and infrared data communications.

The computing environment 900 may further include the computer system 910 operating in a networked environment using logical connections to one or more remote computers, such as remote computing device 980. Remote computing device 980 may be a personal computer (laptop or desktop), a mobile device, a server, a router, a network PC, a peer device or other common network node, and typically includes many or all of the elements described above relative to computer system 910. When used in a networking environment, computer system 910 may include modem 972 for establishing communications over a network 971, such as the Internet. Modem 972 may be connected to system bus 921 via user network interface 970, or via another appropriate mechanism.

Network 971 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 910 and other computers (e.g., remote computing device 980). The network 971 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 971.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine-readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

We claim:

1. A computer-implemented method for profiling a population of examples, the method comprising:
receiving, by a computer, a dataset representative of the population of examples;
receiving, by the computer, a user selection of a population constraint and an indication of a goal;
generating, by the computer, a plurality of shallow fixed-depth trees based on the dataset;
determining, by the computer, a collection of leaves of the plurality of shallow fixed-depth trees meeting the population constraint;
sorting, by the computer, the collection of leaves based on a degree to which the goal is met; and
creating, by the computer, one or more profiles based on the collection of leaves.

2. The method of claim 1, wherein the population constraint corresponds to a percentage of the population of examples that must be covered by at least one leaf in the collection of leaves.

3. The method of claim 1, wherein the goal corresponds to maximizing a characteristic feature of the population of examples.

4. The method of claim 1, wherein the goal corresponds to minimizing a characteristic feature of the population of examples.

5. The method of claim 1, wherein the plurality of shallow fixed-depth trees are each generated using a decision tree algorithm.

6. The method of claim 5, wherein the decision tree algorithm uses information gain to generate the plurality of shallow fixed-depth trees.

7. The method of claim 5, wherein the decision tree algorithm forms splits in the plurality of shallow fixed-depth trees to maximize a combination of population size and mean goal value.

8. The method of claim 1, wherein the collection of leaves of the plurality of shallow fixed-depth trees is determined by a process comprising:
identifying a complete set of leaves included in the plurality of shallow fixed-depth trees; and
removing one or more leaves from the complete set of leaves based on the population constraint to yield the collection of leaves.

9. A computer-implemented method for profiling a population of examples, the method comprising:
receiving, by a computer, a dataset representative of the population of examples;
identifying, by the computer, a subset of the dataset representative of highest performing members of the dataset according to one or more predetermined criteria;
generating, by the computer, a plurality of clusters based on the subset of the dataset;
performing a feature-value pairing process on each cluster, the feature-value pairing process comprising:
forming a plurality of first feature-value pairs that maximally deviate from the population of examples, and
forming a plurality of second feature-value pairs that maximally deviate from remaining clusters in the plurality of clusters; and
creating, by the computer, one or more profiles based on the plurality of first feature-value pairs and the plurality of second feature-value pairs.

10. The method of claim 9, wherein the subset of the dataset representative of highest performing members of the dataset is identified by a process comprising:
identifying a group of members of the population of examples meeting the one or more predetermined criteria;
creating a ranking of the group of members according to a degree to which each respective member of the group meets the one or more predetermined criteria;
selecting the subset of the dataset based on the ranking.

11. The method of claim 10, wherein the subset is limited by a predetermined percentage value selected by a user.

12. The method of claim 11, wherein the subset of the dataset comprises one or more highest-ranking members in the group of members according to the one or more predetermined criteria and the subset of the dataset is sized according to the predetermined percentage value.

13. The method of claim 11, wherein the subset of the dataset comprises one or more lowest-ranking members in the group of members according to the one or more predetermined criteria and the subset of the dataset is sized according to the predetermined percentage value.

14. The method of claim 9, wherein the plurality of clusters is a plurality of disjoint clusters.

15. The method of claim 14, wherein the plurality of clusters are formed using a k-means clustering algorithm.

16. The method of claim 9, wherein, if each member of the population of examples is not represented by the one or more profiles, performing a successive profiling process comprising:
creating a new subset of the population of examples comprising a predetermined percentage of members of the population of examples that are not assigned to the one or more profiles;
forming one or more additional profiles based on the new subset of the members of the population of examples,
wherein the successive profiling process repeats iteratively until each member of the population of examples has been assigned to at least one profile.

17. The method of claim 16, wherein the predetermined percentage of members is based on hardware constraints associated with the computer.

18. A modeling computing system comprising:
a processor configured to retrieve a population dataset from a population database and execute a plurality of modeling components comprising:
a tree formation component configured to process the population dataset into a plurality of decision tree data structures;
a leaf processing component configured to identify a plurality of leaves in the plurality of decision tree data structures meeting a population constraint;
a clustering component configured to form a plurality of disjoint clusters based on the population dataset;
a feature-value pair formation component configured to generate one or more profiles based on one or more feature-value pairs present in the plurality of disjoint clusters; and
a profile database configured to store the one or more profiles.

19. The modeling computing system of claim 18, wherein the plurality of modeling components further comprise:
a dataset filtering component configured to identify a highest-ranking subset or a lowest-ranking subset of the population dataset based on one or more criteria,
wherein the clustering component forms the plurality of disjoint clusters based on the highest-ranking subset of the population dataset or the lowest-ranking subset of the population dataset.

20. The modeling computing system of claim 18, further comprising:
a display module configured to present a graphical depiction of the one or more profiles on a display operably coupled to the modeling computing system, the graphical depiction comprising:
a listing of each feature-value pair associated with the one or more profiles,
an indication of a degree to which each respective feature-value pair in the listing meets a user-defined goal,
an indication of how much of the population dataset meets each respective feature-value pair included in the listing.
